(19) United States
(12) Patent Application Publication
(10) Pub. No.: US 2025/0389523 A1
(43) Pub. Date: Dec. 25, 2025

(54) METHODS AND APPARATUS FOR FIELD MEASUREMENTS

(71) Applicants: Thomas Jacob Flitsch, Moorpark, CA (US); Frederick Flitsch, Framingham, MA (US)

(72) Inventors: Thomas Jacob Flitsch, Moorpark, CA (US); Frederick Flitsch, Framingham, MA (US)

(21) Appl. No.: 19/235,523

(22) Filed: Jun. 11, 2025

Related U.S. Application Data
(60) Provisional application No. 63/663,577, filed on Jun. 24, 2024.

(51) Int. Cl. G01B 3/04; G06Q 30/018; G06Q 50/26; H04N 7/18

(52) U.S. Cl. CPC G01B 3/04; G06Q 30/018; G06Q 50/26; H04N 7/183

(57) ABSTRACT

Methods and apparatus for supporting field assessments of accessibility compliance are disclosed. The Accessibility Reference Stick (ARS) is a portable tool designed to verify compliance with accessibility standards in real-world conditions. The ARS features adjustable pointers set to predefined measurements, modular components for adaptability, digital displays for dynamic reference specifications, and wireless communication capabilities for integration with smart devices. The ARS facilitates photographic documentation of compliance, streamlining inspections and reporting. The ARS design addresses challenges in measuring and documenting accessibility compliance, providing a versatile and efficient solution for field inspectors, architects, and construction professionals.

### CROSS REFERENCE TO RELATED APPLICATIONS

This application claims the benefit of the U.S. Provisional Patent Application Ser. No. 63/663,577 filed Jun. 24, 2024 and entitled METHODS AND APPARATUS FOR FIELD MEASUREMENTS, the contents of each of which are incorporated herein by reference in their entirety.

### FIELD OF THE INVENTION

The present invention relates to tools and methods for verifying accessibility compliance in field conditions. Specifically, the invention provides a portable, modular, and technologically advanced apparatus for measuring and documenting compliance with accessibility standards in built environments.

### BACKGROUND OF THE INVENTION

Ensuring accessibility compliance in building projects and architectural structures is critical to creating environments free of barriers for individuals with disabilities. Compliance with accessibility standards, such as those outlined in the Americans with Disabilities Act (ADA), requires precise measurements and documentation of built features. Existing tools for field measurements are often cumbersome, lack adaptability to varying standards, and fail to provide efficient methods for documenting compliance. For example, inspectors may rely on manual measuring tapes and separate reference guides, which can lead to errors and inefficiencies. Additionally, the lack of tools designed for photographic documentation further complicates reporting. The present invention addresses these challenges by providing a portable, versatile, and technologically advanced tool for verifying accessibility compliance in field conditions.

### SUMMARY OF THE INVENTION

Accordingly, methods and apparatus for supporting the field assessment of compliance to accessibility standards is provided. In some examples, a supporting apparatus may include an Accessibility Reference Stick (ARS) which may have a unique combination of features designed to facilitate the verification of accessibility compliance in actual field conditions. Specifically, the ARS incorporates the following novel elements:

The ARS may include visible pointers that are set at predetermined measurements correlating to various accessibility standards, codes, guidelines, and requirements. This feature may allow for quick and accurate verification of compliance by simply holding the ARS against the feature being measured. In some examples, a main body of the ARS may include a storage element or cavity in which attachments and smaller reference sticks may be stored and accessed.

The pointers on the ARS can be easily adjusted to accommodate different requirements set at predefined set points. This flexibility ensures that the ARS can be used for a wide range of accessibility standards and guidelines, making it a versatile tool for field inspections. In some examples, the pointers may be stored within the storage cavity. In some other examples, the body of the ARS may include a motorized lead screw or movement system which may move pointers to different setpoints. In some examples, user interfaces on display panels of the ARS or on connected smart devices may allow for the choice of a particular standard to be assessed along with movement of the pointer movement system to the desired specification.

The preset points on the ARS may be labeled with the corresponding requirements for elements of a built environment. This labeling may eliminate the need for users to look up references, thereby streamlining the process of verifying accessibility compliance. In some examples, a different stick may be generated for different localities and for different code aspects. In some examples, the ARS may be equipped with one or more display panels along the sides of the ARS that may digitally present the location of reference locations. In some examples, a user interface may be incorporated in the display panels. In some examples, a wirelessly connected smart device may be used to select elements to be displayed along the stick. In some examples, the display systems may be designs which use ambient light to illuminate the display, accordingly the displays may function in various lighting systems including in outdoor locations.

The design of the ARS may facilitate the creation of photo records of the evaluation of elements in actual field conditions. This feature may be particularly useful for documentation and reporting purposes, providing a clear visual record of compliance or non-compliance. In some examples, the ARS may include features that allow it to stand on edge or on its side without support. Accordingly, a camera, video system or smart device may be used to document the isolated ARS in reference to built aspects. Alternatively, a smart device may include a remote activation feature and be placed on a stand or remote stick like support element to document field conditions.

In summary, The Accessibility Reference Stick (ARS) is a novel tool designed to facilitate field assessments of accessibility compliance. The ARS incorporates adjustable pointers set to predefined measurements corresponding to accessibility standards, enabling quick and accurate verification of compliance. Its modular design allows for the inclusion of telescoping extensions, smaller reference sticks, and other attachments stored within an internal cavity. In some examples, the ARS features digital displays that dynamically present reference specifications, which can be controlled via integrated touchscreens or wirelessly connected smart devices. Wireless communication capabilities enable seamless integration with smart devices for data transfer, remote activation, and photographic documentation. In some examples, the ARS also includes self-standing features, allowing hands-free operation for capturing photographic evidence. By addressing the limitations of existing tools, the ARS provides a comprehensive solution for field inspections, ensuring accuracy, efficiency, and adaptability.

### BRIEF DESCRIPTION OF THE DRAWINGS

The accompanying drawings, which are incorporated in and constitute a part of this specification, illustrate several embodiments of the invention and, together with the description, serve to explain the principles of the invention:

FIG. 1A—an illustration of an ARS component design.

FIG. 1B—a top down illustration of an ARS component design.

FIG. 2—an illustration of an exemplary ARS component design in a use condition.

FIG. 3—an illustration of an alternative exemplary ARS component design.

FIG. 4A—an illustration of an alternative exemplary ARS component design with a motorized pointer/flag system.

FIG. 4B—an illustration of an alternative exemplary ARS component design with an internal storage portion and illustrated communications systems.

FIGS. 5-8—illustrations of various reference heights that may be incorporated in various designs.

FIG. 9—an illustration of exemplary methodology associated with the ARS device.

### DETAILED DESCRIPTION OF THE INVENTION

While the invention has been described herein and in following descriptions in conjunction with specific embodiments, it is evident that many alternatives, modifications and variations will be apparent to those skilled in the art in light of the foregoing description. Accordingly, this description is intended to embrace all such alternatives, modifications and variations as fall within its spirit and scope.

An Accessibility Reference Stick (identified herein also as an ARS) may be a tool for confirming accessibility compliance in actual field conditions. All applicable standards, codes, guidelines and requirements for accessible construction elements may be measurable in actual field conditions to determine if the field condition may be free of barriers to use by people with disabilities.

The accessibility reference stick may be a tool that has visible pointers, icons and other indicators set at predetermined measurements that may correlate to standards, codes, guidelines and requirements. Pointers may make it simple to verify compliance by holding the ARS against an exemplary feature. The pointers may be easily adjusted to accommodate different requirements set at predefined set points. Alternative display means of reference locations may also be provided by alternative means such as displays and motorized movements of pointing indicators.

Accordingly, methods and apparatus for supporting the field assessment of compliance to accessibility standards is provided. In some examples, a supporting apparatus may include an Accessibility Reference Stick (ARS) which may have a unique combination of features designed to facilitate the verification of accessibility compliance in actual field conditions. Specifically, the ARS incorporates the following novel elements:

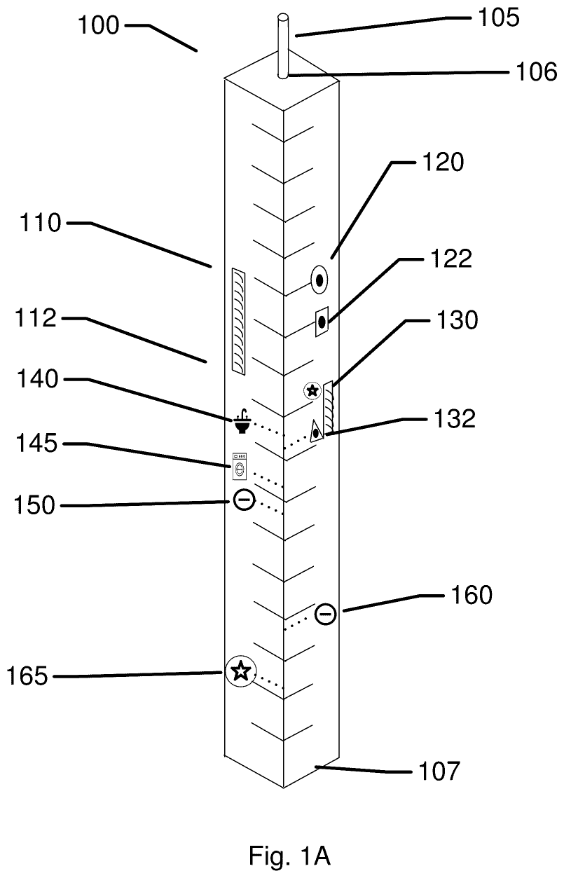

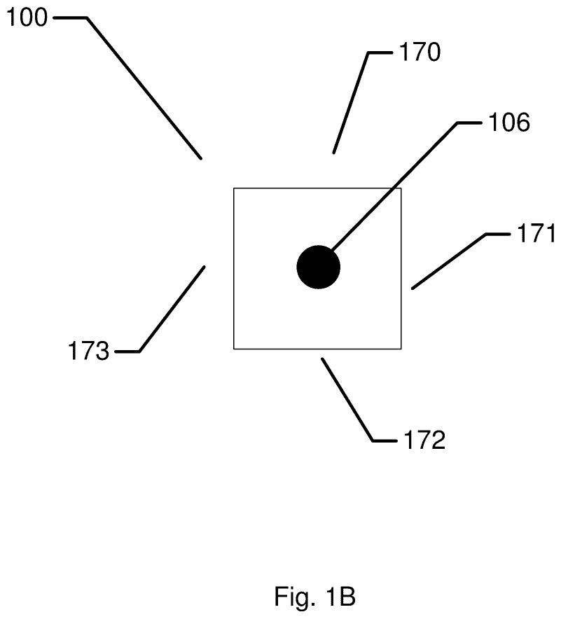

The ARS may include visible pointers that are set at predetermined measurements correlating to various accessibility standards, codes, guidelines, and requirements. Referring to FIG. 1A, an exemplary ARS device 100 with visible reference aspects is illustrated. In some examples, these visible reference aspects may be printed upon the shaft body. In some examples, written text or icons may be used to represent a code related measurement. In some examples, a four sided shaft may be employed. Triangular, or more than four sides may also be employed. In some examples the sides may be alternatively used for measuring features that are vertical in nature or horizontal in nature. In some examples, the vertical “side” may refer to one, two, three or the full four sides. In some examples, the non-vertical side may refer to horizontal features. These design aspects may allow for quick and accurate verification of compliance by simply holding the ARS against the feature being measured.

The ARS device 100 may include features at its ends such as 105 an extension piece which may be screwed into a screw mating feature 106 on the end of the ARS device 100. In some examples, a bottom end 107 may include features that may support the ARS device 100 to stand on its own-such as when photographic evidence may be collected of a compliant or non-compliant measurement at the exact measurement/assessment site. In some examples, a tolerance may include a range of values illustrated for example as a maximum height 110 or minimum height 112 of a feature. In other examples, various dimensions of features 120, 122, 160, 140, 145, 150 and 165 may include iconic representations that can correlate to a particular specification measurement. In some examples, a range may include both a range indication as well as iconic or text descriptions as may be found in the range example for high values 130 to low values 132. For example, the various dimension of features 120, and 122 may refer to horizontal measurements; whereas the various dimension of features 140, 145 and 150 may correspond to vertical features that are specified. In some examples, the stick may be used in just the single configuration with the bottom end 107 at a lower point. In other examples, there may be the ability to align either end vertically and to refer to specific icons to determine the appropriate locations given that orientation.

In some examples, the ARS device 100 may include slots into which different metering displays may slide into with different indicated reference specification. The metering displays may be paper, cardboard, plastic or metal devices which may slide into place along the side of the ARS device 100. In other examples, the different reference indicators may be hinged along the side of the ARS device 100, where a user can open a particular slide to a particular reference slide.

Proceeding to FIG. 1B, a top view of the ARS device 100 is illustrated. As mentioned there may be various numbers of sides in different examples. In the illustration, a four sided ARS device 100 may include sides 170,171,172 and 173. These different sides may relate to different types of measurements such as vertical and horizontal measurements. Again, in some examples, a screw mating feature 106 may be located at a top or bottom of the ARS device 106. In some other examples, slots or other means of capturing devices may be included instead of or in addition to the screw mating feature 106. In some examples, a laser or sonar measuring device may be affixed into the screw mating feature 106 or other mating feature type to allow for extended measurement above the shaft. In some examples, a projector of light such as laser light may be attached to the screw mating feature 106 to allow for display of information on walls or ceilings around the ARS device 100.

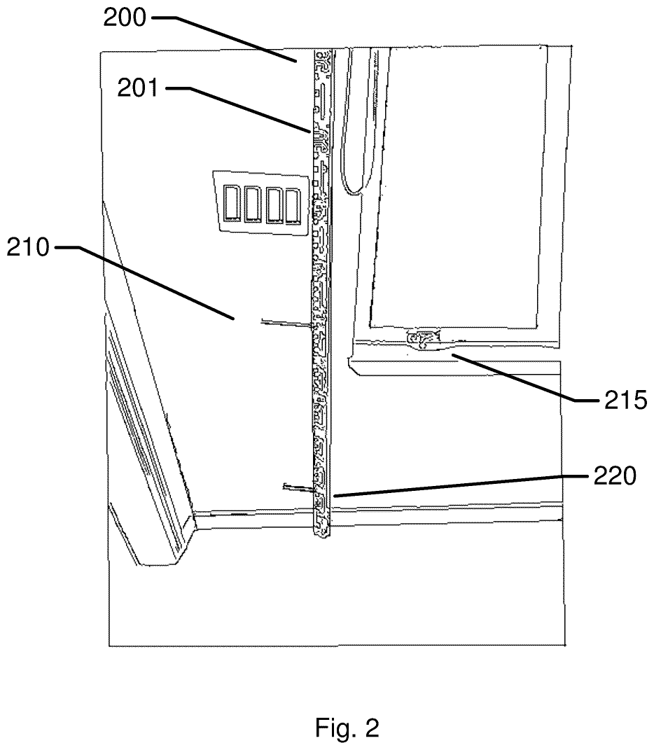

Referring now to FIG. 2, an illustration of an ARS device 200 in a measurement location is provided. The ARS device may have various text and iconography, or icon sets along its body 201. In some examples, a side of the ARS device 200, may include screw mating features to hold pointers 210 and 220 at certain heights. In some other examples, pointing features may be able to slide along the side of the ARS device 200 to match a reference specification location. In the illustration of FIG. 2, a representation of a photographic result of the ARS device positioned relative to built features may be illustrated. In some examples, a smart device may be used to take the photographic result. Associated metadata such as position, elevation, time and date and the like may be included. In some examples, an ARS device 200 may include electronics to allow for wireless transmission between the ARS device 200 and a smart device such as with Bluetooth, cellular, WiFi or similar communication modes. In some examples, the electronics may include transferring data such as an identification of the ARS device 200 such as a serial number, model number, basic information about its dimensions and the like. In some examples, the individual measuring tapes or plates that are active on the device may also be communicated. As well, there may be functionality to allow for activation of the camera system from the stick. In some examples, attached or internal laser measuring devices may pass their information to an attached smart device as well.

The smart device may include application software that is designed to operate with the ARS device 200. The smart device may include processing hardware and memory hardware to store and process application software and associated programs and data stores.

In some examples, a main body of the ARS device 200 may include a storage element or cavity in which attachments and smaller reference sticks may be stored and accessed.

The pointers on the ARS device 200 may be easily adjusted with a sliding system that include a reference pointer to the physical scale. In some examples, the adjusted locations may accommodate different requirements set at predefined set points. This flexibility may ensure that the ARS device 200 may be used for a wide range of accessibility standards and guidelines, making it a versatile tool for field inspections.

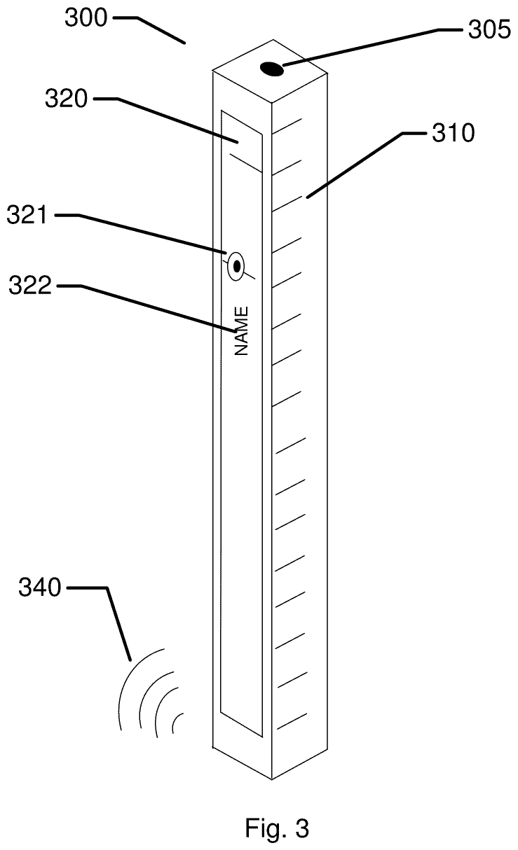

Referring now to FIG. 3, an illustration of a different example type of the measuring stick apparatus is show with reference to ARS device 300 which may include a digital display 320 on one or more sides of the device body. Internal electronic devices with the ARS device 300 may control digital output to the digital display 320. The digital display may be used to present user dialogs to choose particular reference specifications to display. In other examples, a smart device may communicate wirelessly with wireless communication capabilities 340 of the ARS device 300, which again may include WiFi, Bluetooth, Near Field communications, Cellular and other such wireless communications protocols. An application software of the smart device may have functionality to communicate with the ARS device 300 and provide display information for the digital display which may indicate a reference location 321 which may include an icon as well as the ability to describe the reference location with an icon or textual display 322. In some examples, the digital display may have touch screen capabilities in part of the length or the whole. In some examples, the touch screen may enable a user interface to select specifications or to control other functionality. In some examples, a touch screen icon may activate a function when pressed to take a picture with an attached smart device which may be communicated with wireless communication capabilities 340. In some examples the touch screen may also include function to control other devices associated with or built into the ARS device 300 such as in a non-limiting perspective laser measurement devices, sonic measuring devices, camera modules, electronic leveling devices, sound interface including microphones or speakers and the like. In some examples, additional text may be displayed in the digital display that may be useful to be captured in a photo taken of the ARS device 300 in a measurement location such as time/date, username, location name and the like.

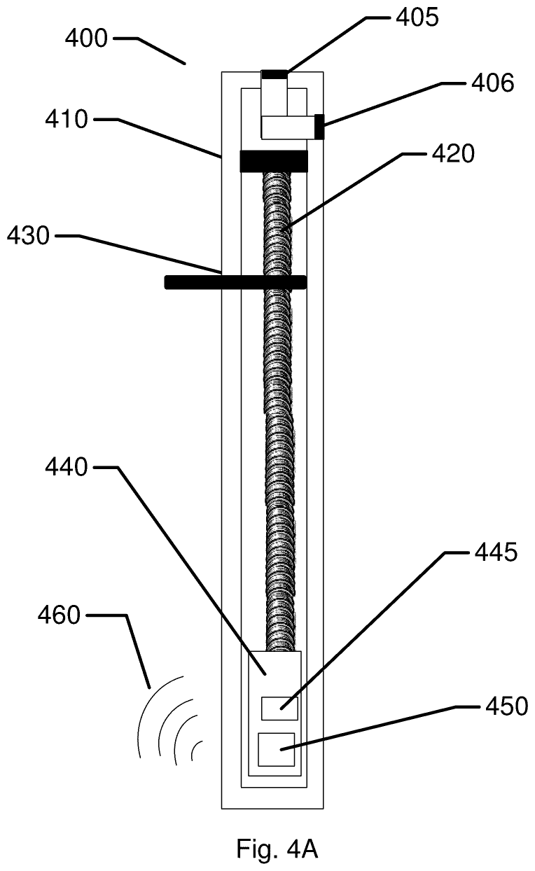

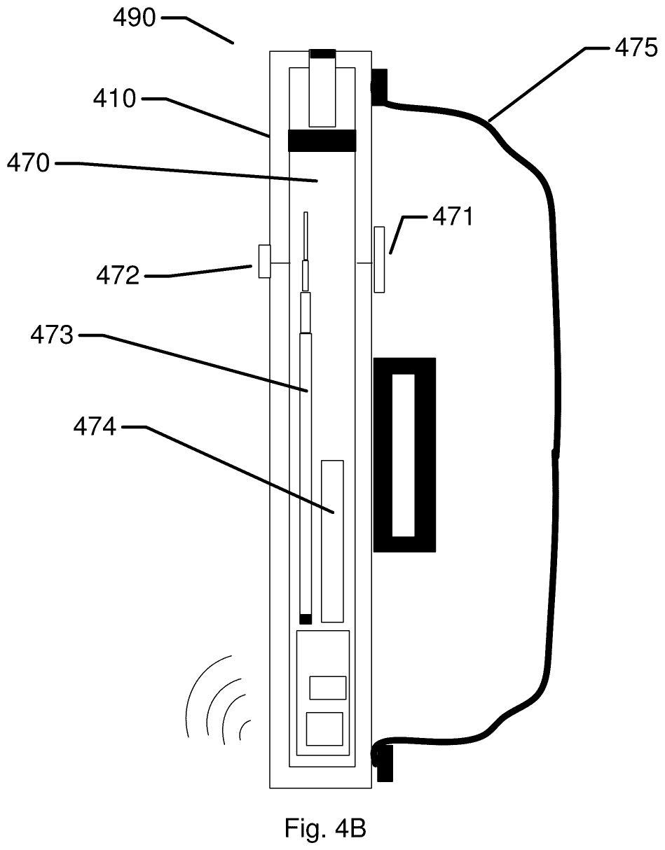

Referring now to FIG. 4A, in some examples an ARS device 400 may include internal features in its body 400. For example, laser measurement devices 405 and 406 may be included within the body of the ARS device 400. In some examples, a movement element such as a lead screw 520 with a motor function 440 may be used to move an external pointer 430 to a desired location along the body of the ARS device 400 to indicate a reference location. In some examples, the ARS device 400 may include internal electronics 445 and internal energy storage 450 to operate and power control functions and the motors of the movement element as well as other elements such as external displays, wireless communications functions 460, laser measurement devices, cameras, illumination elements and the like.

Referring now to FIG. 4B, another example of an ARS device 490 is illustrated with additional functionality. In some examples, the body 410 of the ARS device 490 may include a cavity 470 that may be accessed for stored elements. Within the cavity, items such as a measurement extension 473 which in some examples may be telescoping and smaller measurement sticks 474 may be stored. Other items may also be included within the cavity 470. In some examples, the pointers may be stored within the storage cavity. In some other examples, the body of the ARS may also include a motorized lead screw or movement system which may move pointers to different setpoints. In some examples, user interfaces on display panels of the ARS or on connected smart devices may allow for the choice of a particular standard to be assessed along with movement of the pointer movement system to the desired specification. In some examples, the ARS device 490 may be opened to access the cavity. In some examples, a hinge system 471 with a latch 472 may be used to open up the cavity. In some other examples, the body may include a different sized cap that may slide over a second part of the body 410 to contain materials within the cavity. In some examples the ARS device 490 may have features to support the carrying of the device to a job site or within a job site such as in a non-limiting example a strap 475. The strap may include clips or other attachment features such that it may also be stored within the cavity in a non-carrying state.

The preset points on the ARS may be labeled with the corresponding requirements for elements of a built environment. This labeling may eliminate the need for users to look up references, thereby streamlining the process of verifying accessibility compliance. In some examples, a different stick may be generated for different localities and for different code aspects. In some examples, the ARS may be equipped with one or more display panels along the sides of the ARS that may digitally present the location of reference locations. In some examples, a user interface may be incorporated in the display panels. In some examples, a wirelessly connected smart device may be used to select elements to be displayed along the stick. In some examples, the display systems may be designs which use ambient light to illuminate the display, accordingly the displays may function in various lighting systems including in outdoor locations.

The design of the ARS may facilitate the creation of photo records of the evaluation of elements in actual field conditions. This feature may be particularly useful for documentation and reporting purposes, providing a clear visual record of compliance or non-compliance. In some examples, the ARS may include features that allow it to stand on edge or on its side without support. Accordingly, a camera, video system or smart device may be used to document the isolated ARS in reference to built aspects. Alternatively, a smart device may include a remote activation feature and be placed on a stand or remote stick like support element to document field conditions.

The accessibility reference stick's preset points may be labeled so the requirements for elements of a built environment may be easily referenced.

In some examples, light emitting components such as leds along the length of the staff may be used to indicate locations. In some examples, the staff may include a display element and an ability to input and output content.

In some examples, an ARS device may include the ability to make spoken commands to activate functionality. In some examples, the staff may include data related to accessibility codes stored within memory on the device. In some other examples, the staff may utilize a connection to a smart device, or other communications connected device to access code related data or other reference information for the site being reviewed in the field.

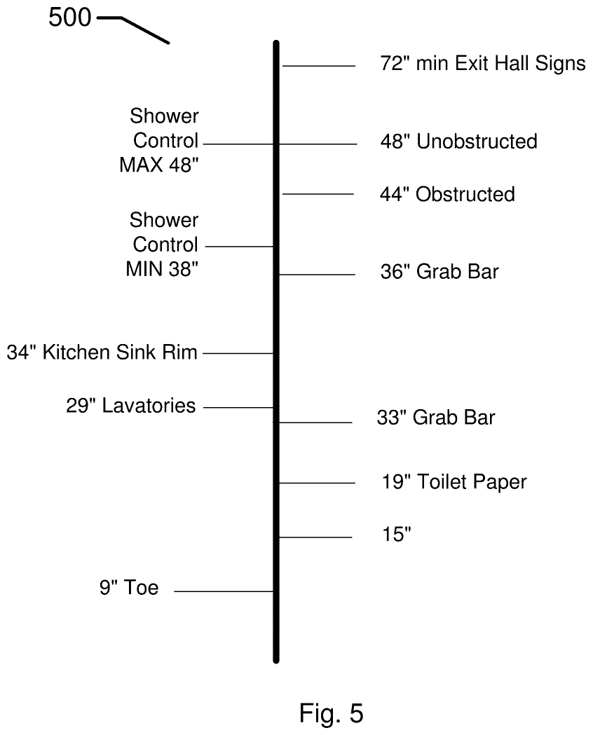

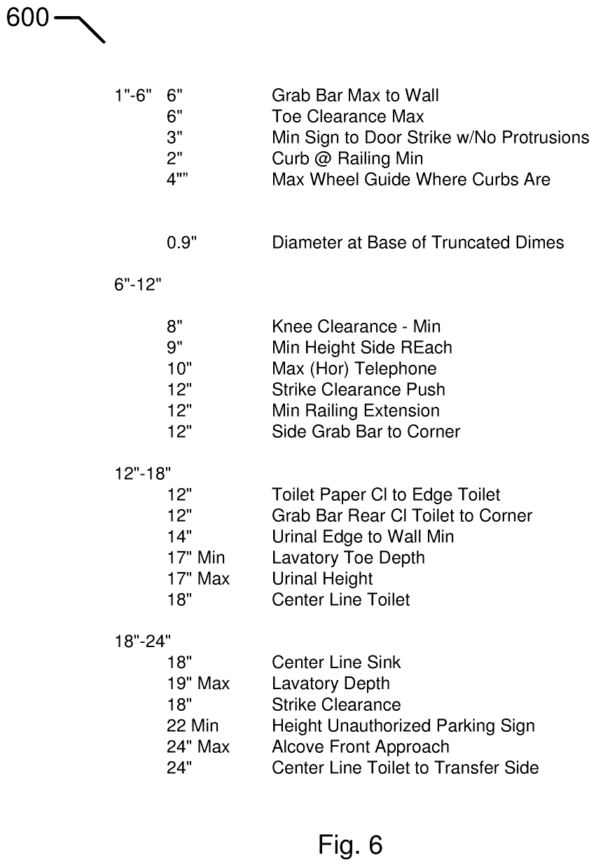

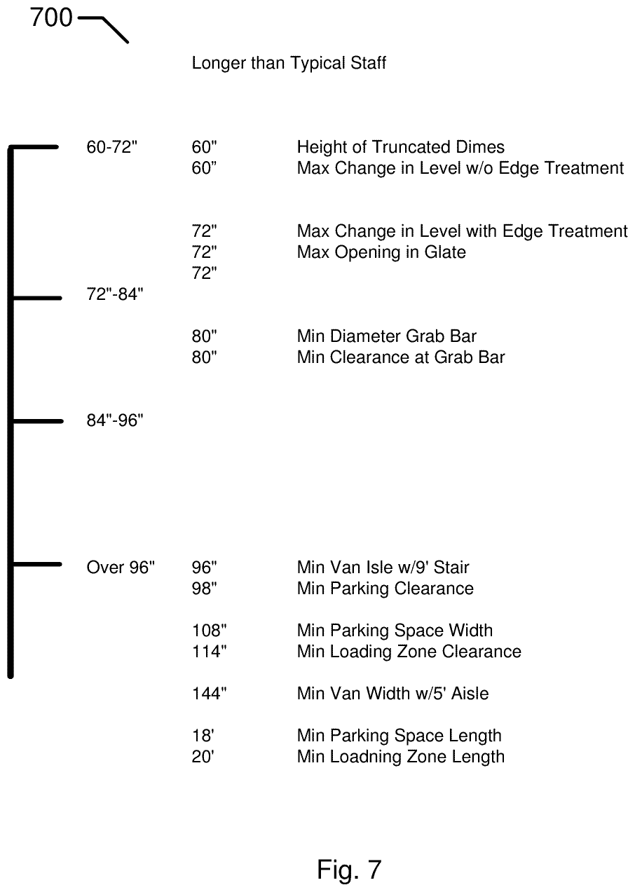

As depicted in FIGS. 5-7, items 500-700 there may be various reference heights or lengths that may be indicated or referenced to an exemplary ARS as described in the figures. For example, the ARS Device may include essential ADA dimensions such as knee and toe clearances, low and high reach ranges, grab bar positions, and sink and counter heights. Examples include 27-inch minimum knee clearance, 9-inch toe clearance, 15-inch minimum low reach, 48-inch maximum unobstructed reach, and grab bar height ranges from 33 to 36 inches. The staff is color-coded for ease of reference in the field—typically distinguishing vertical vs. horizontal measures. One embodiment may include dimensions grouped by face, such as bathrooms on one side, kitchens on another, paths of travel on the third, and miscellaneous codes on the fourth.

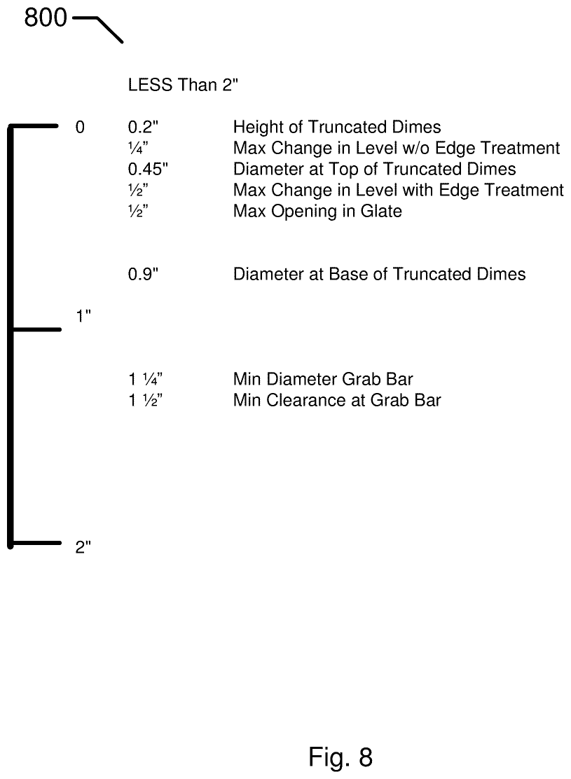

Special design considerations include a modular architecture: a pop-up tool or internal gauge which may be stored within a cavity may be used for small-dimension measurements, such as 6-inch offsets, grab bar diameters, and truncated dome dimensions. As non-limiting examples, referring to FIG. 8, item 800, some examples of small features which may be measured with an internal gauge are illustrated.

In conjunction with this, the ARS device may include or be used with a selfie stick to aid photographic documentation, enabling inspectors to frame and capture measurements clearly. Again, the ARS device may may be designed to be self-standing, facilitating hands-free operation and photography.

### Methodology

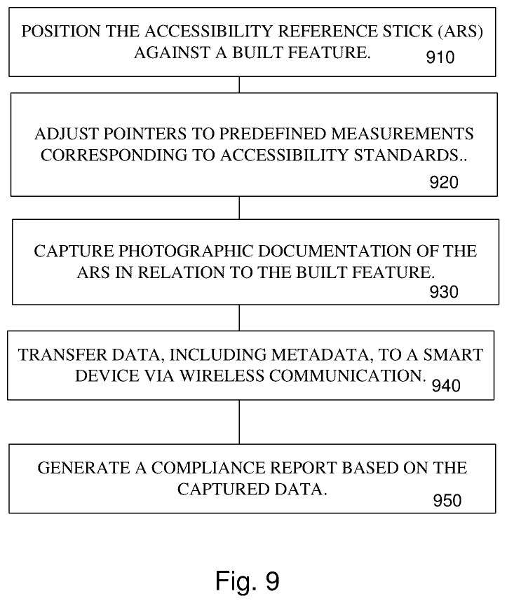

Various methods may relate to the ARS device. Exemplary methods may include a method for using an ARS device for verifying accessibility compliance in field conditions. Referring to FIG. 9, a method may include a step 910 to position the Accessibility Reference Stick (ARS) against a built feature. The method may also include a step 920 to adjust pointers to predefined measurements corresponding to accessibility standards. The method may include a step 930 to capture photographic documentation of the ARS in relation to the built feature. The method may include a step 940 to transfer data, including metadata, to a smart device via wireless communication. And the method may include a step 950 to generate a compliance report based on the captured data.

In some examples, methods may also include steps to include metadata in captured data such as including time, date, location, and user identification in the metadata. The methods may also include steps to ensure that metadata is automatically associated with photographic documentation.

In some examples, methods may also include steps for remote control of the ARS device. The steps may include using a smart device to wirelessly connect to the ARS. The steps may include remotely controlling pointer adjustments and other ARS functionalities.

In some examples, methods may include steps for overlayed digital annotations. The steps may include capturing photographic documentation of the ARS in relation to the built feature. The steps may include overlaying digital annotations indicating compliance measurements on the photographs.

In some examples, methods may include steps for measuring vertical and horizontal dimensions. The steps may include using the ARS to measure vertical dimensions of built features. The steps may include using the ARS to measure horizontal dimensions of built features.

In some examples, methods may include steps for automatic compliance report generation. The steps may include transferring measurement data and metadata to a smart device. The steps may include integrating software to automatically generate a compliance report.

In some examples, methods may include steps for verifying multiple accessibility standards. The steps may include selecting multiple accessibility standards using the ARS or smart device interface. The steps may include adjusting pointers to match the requirements of each selected standard. The steps may include verifying compliance with multiple standards simultaneously.

### CONCLUSION

The Accessibility Reference Stick (ARS) is a portable tool designed to verify accessibility compliance in field conditions. In various embodiments, the ARS may include the following key features:
1. Adjustable Pointers/Reference Features: The ARS features visible pointers, reference lines, text and icons, set to predefined measurements corresponding to accessibility standards. These pointers may be adjusted manually or via a motorized lead screw system, allowing for flexibility in verifying compliance with various standards.
2. Modular Design: The ARS may include an internal cavity for storing attachments, such as telescoping extensions and smaller reference sticks. These modular components may enhance the tool's adaptability to different measurement scenarios.
3. Digital Displays: In some examples, integrated digital displays may dynamically present reference specifications, which can be controlled via touch screens or wirelessly connected smart devices. The displays may include ambient light illumination for various use cases and provide user interfaces for selecting standards and controlling other functionalities.
4. Wireless Communication: The ARS may be equipped with wireless communication capabilities, including Bluetooth, Wi-Fi, and cellular protocols. These features may enable integration with smart devices for data transfer, remote activation, and photographic documentation.
5. Photographic Documentation: The ARS may include self-standing features, allowing it to be positioned independently for hands-free operation. This facilitates the creation of photographic records of compliance, which can include metadata such as time, date, and location.
6. Additional Features: The ARS may include laser measurement devices, sound interfaces, and voice command capabilities. These features may further enhance its functionality and ease of use in some examples.

Particular embodiments of the subject matter have been described. Other embodiments are within the scope of the following claims. In some cases, the actions recited in the claims may be performed in a different order and still achieve desirable results. In addition, the processes depicted in the accompanying figures or described in the discussion herein, do not necessarily require the particular order shown or described, or a particular sequential order, to achieve desirable results. In certain implementations, multitasking and parallel processing may be advantageous. Nevertheless, it will be understood that various modifications may be made without departing from the spirit and scope of the claimed invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising”, “including”, and “having” can be used interchangeably.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

As has been mentioned, the illustrations depict aspects of exemplary embodiments, and the relative scale of illustrated features may be exaggerated for depiction of various aspects. Accordingly, the scale of features illustrated is not intended to limit the scope of the elements of the various embodiments consistent with the present application.

What is claimed is:

1. An apparatus for verifying accessibility compliance in field conditions, comprising:
a main body with visible features set to predefined measurements corresponding to accessibility standards;
adjustable pointers configured to move to different setpoints manually or via a motorized system; and
a self-standing feature for hands-free operation and photographic documentation.

2. The apparatus of claim 1, further comprising:
one or more digital displays configured to dynamically present reference specifications; and
wireless communication capabilities for integration with smart devices.

3. The apparatus of claim 1 further comprising an internal cavity for storing modular components, including telescoping extensions and smaller reference sticks.

4. The apparatus of claim 1, further comprising laser measurement devices integrated into the main body.

5. The apparatus of claim 1, further comprising light-emitting components along the length of the main body to indicate reference locations.

6. The apparatus of claim 1, further comprising a strap or carrying mechanism for portability.

7. The apparatus of claim 1, wherein the self-standing feature includes a weighted base for stability on uneven surfaces.

8. The apparatus of claim 2, further comprising voice command capabilities for activating specific functions.

9. The apparatus of claim 2, wherein the digital displays include touchscreens for user interface functionality.

10. The apparatus of claim 2, wherein the wireless communication capabilities include Bluetooth, Wi-Fi, and cellular protocols.

11. A method for verifying accessibility compliance in field conditions, comprising:
positioning an Accessibility Reference Stick (ARS) against a built feature;
adjusting pointers to predefined measurements corresponding to accessibility standards;
capturing photographic documentation of the ARS in relation to the built feature;
transferring data, including metadata, to a smart device via wireless communication;
generating a compliance report based on the captured data.

12. The method of claim 11, wherein the metadata includes time, date, location, and user identification.

13. The method of claim 11, further comprising the step of using a smart device to remotely control the ARS.

14. The method of claim 11, wherein the photographic documentation includes overlayed digital annotations indicating compliance measurements.

15. The method of claim 11, further comprising the step of using the ARS to measure both vertical and horizontal dimensions of built features.

16. The method of claim 11, wherein the compliance report is automatically generated by software integrated with the smart device.

17. The method of claim 11, further comprising the step of using the ARS to verify compliance with multiple accessibility standards simultaneously.

18. A system for verifying accessibility compliance in field conditions, comprising:
an Accessibility Reference Stick (ARS) with adjustable pointers, digital displays, and wireless communication capabilities;
a smart device configured to wirelessly communicate with the ARS; and
application software installed on the smart device, the software configured to:
control the ARS;
capture and store photographic documentation; and
generate compliance reports based on measurements and metadata.

19. The system of claim 18, wherein the application software includes a user interface for selecting accessibility standards and controlling pointer adjustments.

20. The system of claim 18, further comprising a remote activation feature for capturing photographs using the smart device.
